(19) United States
(12) Patent Application Publication
(10) Pub. No.: US 2018/0247162 A1
(43) Pub. Date: Aug. 30, 2018

(54) METHOD FOR CAPTURING AND CLASSIFYING OBJECTS

(71) Applicant: Henkel AG & Co. KGaA, Duesseldorf (DE)

(72) Inventor: Clemens Arth, Graz (DE)

(21) Appl. No.: 15/840,285

(22) Filed: Dec. 13, 2017

(30) Foreign Application Priority Data
Dec. 21, 2016 (DE) 102016225806.0

(51) Int. Cl. G06K 9/62

(52) U.S. Cl. CPC G06K 9/6269; G06T 7/20

(57) ABSTRACT

A method including: a first capturing of pieces of information, wherein the first captured pieces of information are indicative of an area to be monitored; evaluating the first captured pieces of information, wherein the first captured pieces of information are evaluated for the presence of an object; specifying at least one parameter based on the evaluation, wherein the at least one specified parameter is indicative of a capturing of the object; a second capturing of pieces of information based on the at least one specified parameter, wherein the second captured pieces of information are indicative of the object; and ascertaining at least one piece of classification information based on the second captured pieces of information, wherein the piece of classification information is indicative of a classification of the object.

### FIELD OF THE INVENTION

The invention relates to methods and to devices by way of which, via a first capturing of pieces of information indicative of an area to be monitored, the presence of an object can be detected. Furthermore, a second capturing of pieces of information indicative of the object can take place based on at least one specified parameter, and a piece of classification information can be ascertained, wherein the piece of classification information is indicative of a classification of the object.

### BACKGROUND OF THE INVENTION

It is known to capture pieces of information, for example, by way of a camera, and to examine these for the presence of objects. This is known from the technical field of monitoring technology, for example. In the captured pieces of information, for example, the presence of a person and/or of an object can be detected.

A detection of smaller objects, such as the detection of pests, for example, is usually carried out by the human eye, for example in that a person identifies a pest in an area and, for example, carries out an appropriate measure, such as initiates and/or carries out pest control.

Furthermore, it is known to use systems for at least partially automatically initiating pest control measures, which release a predetermined amount of a chemical within an area, for example automatically, at regular intervals, wherein the chemical is intended to control pests. Moreover, further sensors can be provided, which are able to capture the amount of chemical already released in the area, for example, and accordingly control further release of the chemical to achieve a predefined dosage.

The problem, however, is that such systems are generally only tailored to a certain type of pest, which must be known in advance. If additional types of pests are present in the area, for example at a later point in time, which cannot be controlled by the chemical of the system, such systems at times require complex steps to be converted and/or configured for the additional type of pest. It is furthermore problematic that it is often difficult to determine the type of pest involved, since a pest generally must be seen only by the human eye and, additionally, the type of pest must be determined thereafter.

To control pests efficiently and quickly, in particular reliable and fast identification and classification of the pest is needed.

### BRIEF SUMMARY OF THE INVENTION

Against the background of the prior art, it is therefore the object of the invention to reduce or avoid at least some of the described problems, and in particular to enable a reliable and fast identification and classification of an object at least in a partially automatic manner.

According to a first aspect of the invention a method is described, the method comprising:
a first capturing of pieces of information, wherein the first captured pieces of information are indicative of an area to be monitored;
evaluating the first captured pieces of information, wherein the captured pieces of information are evaluated for the presence of an object;
specifying at least one parameter based on the evaluation, wherein the at least one specified parameter is indicative of a capturing of the object;
a second capturing of pieces of information based on the at least one specified parameter, wherein the second captured pieces of information are indicative of the object; and
ascertaining at least one piece of classification information based on the second captured pieces of information, wherein the piece of classification information is indicative of a classification of the object.

According to a second aspect of the invention, a device is described which is configured or comprises appropriate means to carry out and/or to control a method according to the first aspect. Devices of the method according to the first aspect are or comprise in particular one or more devices according to the second aspect.

A first capturing of pieces of information takes place, wherein the first captured pieces of information are indicative of an area to be monitored. An area to be monitored may be a territory, a surface area or a space, for example, wherein the territory, the surface area or the space is to be monitored. For this purpose, first pieces of information are captured, wherein these first captured pieces of information can include characteristic information with respect to the area, for example. Characteristic pieces of information with respect to the area, for example, can represent the surroundings of the area, objects located in the area or the like.

Furthermore, the first captured pieces of information are evaluated, wherein the first captured pieces of information are evaluated for the presence of an object. For example, the first captured pieces of information can be evaluated as to whether an object is present in the area to be monitored, which, for example, was not present in the area to be monitored at an earlier point in time. For example, the area to be monitored can be mapped in a model based on captured pieces of information for this purpose. The first captured pieces of information can be compared to this model, for example, wherein, for example, differences between the first captured pieces of information and the model mapped at an earlier point in time based on captured pieces of information can be captured. These differences may point to the presence of an object. Significant differences, for example, can be triggered in particular by the movement of a person or an object.

Based on the evaluation of the first captured pieces of information, at least one parameter can be specified. The specified parameter can be indicative of a capturing of the object. For example, the specified pieces of information can comprise a region within the area to be monitored in which the object is present. Accordingly, it is possible to carry out further capturing of pieces of information. The capturing of these further pieces of information is limited to the region within the area to be monitored. Accordingly, it is possible, for example, to capture further pieces of information that, with respect to the object present in the area to be monitored, are captured at a higher level of detail as compared to the first captured pieces of information, which are indicative of the area to be monitored. Due to the limitation to a region within the area, for example, more details can be captured than during the first capturing of pieces of information indicative of the area to be monitored, using the same volume of captured pieces of information. The at least one specified parameter can comprise a location, for example, wherein the location is indicative of the region within the area to be monitored, and/or data that allows a capturing of pieces of information based on the at least one specified parameter in such a way that a second capturing of pieces of information, which are indicative of the object, is possible.

A second capturing of pieces of information based on the at least one specified parameter can take place, wherein the second captured pieces of information are indicative of the object. By capturing pieces of information based on the at least one specified parameter, it can be ensured that pieces of information are captured, these captured pieces of information being indicative of the object. For example, in this way more details with respect to the object can be captured since, as a result of the capturing of pieces of information based on the at least one specified parameter, it is possible, for example, to capture a region and/or a subregion within the area to be monitored in which the presence of the object was detected and/or evaluated, for example, within the scope of the evaluation of the first captured pieces of information. The second captured pieces of information can thus, for example, have a higher level of detail with respect to the object than the first captured pieces of information.

Furthermore, at least one piece of classification information is ascertained based on the second captured pieces of information, wherein the piece of classification information is indicative of a classification of the object. The second captured pieces of information, which are indicative of the object, can be classified, wherein a piece of information is ascertained. The piece of classification information is indicative of a classification of the object. For example, the piece of classification information can be indicative of an object type, an object species and/or an object nature, so that corresponding information can be ascertained. Accordingly, it can be ascertained during the ascertainment of an object type, for example, what the object is, for example a person or an animal or the like. During the ascertainment of an object species, it can be ascertained, for example, what the species of the object is, for example whether it is an insect or a mammal. Furthermore, a classification to that effect can also be carried out, wherein the significance of the object for the area to be monitored is taken into consideration. For example, it can be ascertained that the object is a pest that, for example, is harmful for the area and/or for goods present within the area. Furthermore, an object may be classified as a pest for an area to be monitored, while being classified a non-pest for another area to be monitored. During the ascertainment of an object nature, for example, the exact nature of the object may be ascertained, for example whether the object involves an animal, and more precisely an insect, and/or the species of the object, such as the species of the insect, may be ascertained, for example. The object can be appropriately classified, and a corresponding piece of classification information can be ascertained.

In one exemplary embodiment of the invention, it is provided that the object is a pest, and the at least one piece of classification information is indicative of a pest type. For example, during the first capturing of pieces of information, pieces of information that are indicative of an area to be monitored can be captured. For example, according to the method according to aspects of the invention, the area can be monitored with respect to present pests, or with respect to pests penetrating into the area to be monitored in the course of the monitoring process. The first captured pieces of information are evaluated, wherein the first captured pieces of information are evaluated for the presence of a pest. Within the scope of the evaluation, for example, the presence of a pest can be detected or evaluated in that a movement of the pest within the area is evaluated by evaluating the first captured pieces of information.

Once the presence of a pest was evaluated within the scope of the evaluation of the first captured pieces of information, at least one parameter can be specified based on the evaluation, wherein the at least one specified parameter is indicative of a capturing of the pest. For example, the at least one parameter may be specified to the effect that it is possible to capture pieces of information indicative of the pest based on the at least one specified parameter. This, for example, comprises a capturing of pieces of information that are indicative of the pest, for example in that the captured pieces of information comprise detailed pieces of information with respect to the pest. For example, the captured pieces of information can comprise a detailed image of the pest, so that the outward appearance of the pest is captured with a relatively high number of details compared to an image of the entire area to be monitored. First captured pieces of information, which are indicative of the area to be monitored, for example, can likewise comprise pieces of information with respect to the outward appearance of the pest; however, since the size of the pest present within the area to be monitored, for example, is very small in relation to the area, at times fewer details of the pest can be captured.

Accordingly, a second capturing of pieces of information based on the at least one specified parameter can take place, wherein the second captured pieces of information are indicative of the pest. Based on the second captured pieces of information, at least one piece of classification information can be ascertained, wherein the piece of classification information is indicative of a classification of the pest.

The classification of the pest can be determined based on the outward appearance of the pest, for example, so that, for example, it is possible to ascertain the pest type, the pest species and/or the nature of the pest. Furthermore, at least one piece of classification information can be ascertained based on the second captured pieces of information, for example by evaluating a movement pattern of the pest. A movement pattern, for example, can be the manner in which a pest travels on paths. This path may be indicative of a specific pest, whereby the pest can be classified based on the movement pattern and at least one piece of classification information can be ascertained.

It is consequently possible in this way to detect the presence of a pest within an area to be monitored, to track the movement thereof within the area, and to classify the pest.

According to one exemplary embodiment according to aspects of the invention, the ascertainment of at least one piece of classification information takes place by way of a neural network, wherein the second captured pieces of information are used as input parameters for the neural network, and at least one piece of classification information is output by the neural network.

The neural network can be trained during an initial phase, for example, so that it is possible to ascertain at least one piece of classification information. Furthermore, the neural network can continue to learn during ongoing operation, so as to increase the likelihood that least one accurate piece of classification information is output and, compared to a non-learning classification, such as a static algorithm, thereby supply a better because more accurate result of the classification in the form of a piece of classification information.

The ascertainment of at least one piece of classification information by way of the neural network can take place, for example, by way of what is known as a convolutional neural network (CNN), support vector machines (SVM) or self-organizing maps (SOM). The ascertainment of at least one piece of classification information preferably takes place by way of a convolutional neural network (CNN), and most particularly preferably by way of what is known as a deep CNN. A deep CNN comprises one or more processing layers that the pieces of information pass through as input parameters for the neural network. The respective processing layers carry out one or more linear and/or non-linear transformations of the pieces of information used as input parameters, so that the neural network outputs, as the result, at least one piece of classification information, for example of a pest represented by the pieces of information, which are used as input parameters for the neural network. The one or more processing layers of the neural network, for example, can comprise an input layer, one or more hidden layers, and an output layer, which each carry out one or more operations, such as linear and/or non-linear transformations as operations of the pieces of information. The operations of the neural network can be carried out and/or controlled by a processor, for example. Alternatively, what is known as a computational engine and/or a linked computational engine can implement the neural network, for example, and/or can carry out and/or control the operations of the neural network.

As an alternative or in addition, the ascertainment of at least one piece of classification information takes place by way of classification information by way of the neural network, namely by way of what is known as support vector machines (SVM) or self-organizing maps (SOM), for example.

One exemplary embodiment according to aspects of the invention provides for the steps of the second capturing of pieces of information and of ascertaining at least one piece of classification information to be carried out at least twice so as to obtain at least two pieces of classification information. Accordingly, for example, the second capturing of pieces of information can take place at differing points in time, so that, for example, the object or the pest can be tracked, for example within the scope of a tracking process. Moreover, at least two pieces of classification information can be ascertained. The at least two pieces of classification information can comprise the same classification of the object to be classified and/or of the pest to be classified, so that the classification is extremely likely to be accurate. If the ascertained at least two pieces of classification information should differ from one another, it is possible, for example, to carry out the steps of the second capturing of pieces of information and of ascertaining at least one piece of classification information yet again so as to ascertain a further piece of classification information.

Furthermore, the pieces of classification information can be weighted, for example by assigning a likelihood to the piece of classification information, whereby inference with respect to an accurate classification of the object and/or of the pest is possible. When at least two pieces of classification information are present, in this way it is possible to ascertain the piece of classification information which is more likely to accurately classify the object to be classified.

In one exemplary embodiment according to aspects of the invention, a method is provided, furthermore comprising:
ascertaining a piece of result information based on at least two pieces of classification information, wherein the piece of result information is indicative of the most likely classification of the object.

The piece of result information can, for example, determine a piece of classification information from at least two ascertained pieces of classification information. For this purpose, for example, the classification of the object and/or of the pest that is most likely the accurate one can be determined as the piece of result information. Furthermore, the piece of result information can be ascertained such that the piece of classification information which was ascertained with the highest frequency is ascertained as the piece of result information.

One embodiment according to aspects of the invention provides a method, furthermore comprising:
outputting and/or triggering a predefined action as a function of the piece of result information, wherein the predefined action is indicative of a recommendation of a measure based on the at least one ascertained piece of classification information and/or piece of result information.

The predefined action can be output and/or the output thereof can be initiated and/or the predefined action can be triggered and/or the triggering thereof can be initiated. For example, a predefined action can be indicated to a user on a display device, so that, for example, the user can carry out and/or initiate a recommendation of a suitable or optimal measure with respect to the pest. The display on the display device can in particular take place visually and/or acoustically. Moreover, for example, a contact person and/or the user can be notified, for example by transmitting a message to the contact person and/or the user via a communication interface. It is conceivable, for example, to transmit a message via the Internet, which the contact person and/or the user can receive, for example in the form of an e-mail. Additionally or alternatively, it is furthermore conceivable that a notification is transmitted to the contact person and/or the user via a mobile communication network.

Furthermore, a pest control measure can be carried out and/or the execution thereof can be initiated at least partially automatically as a predefined action, for example in that a pest control agent and/or a suitable insecticide is sprayed. For example, the at least one parameter for controlling an optical sensor element can be specified as a predefined action, so that the pest can be tracked, for example, when the pest changes position within the area to be monitored. Furthermore, a predefined action could also involve ignoring the pest, provided this appears to be a suitable measure. For example, ignoring can take place based on at least one further parameter, wherein the at least one further parameter rates the pest as non-critical for the area to be monitored. Furthermore, for example, an algorithm may be used and/or employed, which can be used to weight and/or cast a vote regarding at least two pieces of classification information so as to determine a suitable measure, which can be output and/or triggered as a predefined action, for example. One or more suitable measures can be documented in a database, for example, which a processor can access, for example, so as to process data stored in the database.

In one exemplary embodiment according to aspects of the invention, the first capturing of pieces of information and/or the second capturing of pieces of information take place by way of an optical sensor element. For example, the optical sensor element can be a camera, and in particular what is known as a pan-tilt-zoom (PTZ) camera, an infrared camera, a thermal imaging camera and/or a photonic mixer device. Furthermore, the optical sensor element can comprise an image sensor, and in particular a digital image sensor. Furthermore, a monochrome sensor could be used, which captures pieces of information without color resolution. Moreover, optical sensor elements that are limited to certain wavelength ranges can be used, for example based on at least one photodiode and/or at least one LED element. An infrared camera and/or a thermal imaging camera represent one possible embodiment. Using an infrared camera and/or a thermal imaging camera, the captured pieces of information can be evaluated by evaluating the presence of a pest, for example based on the captured infrared radiation. An increased temperature in a region of the area to be monitored, for example, may be indicative of the presence of a pest. A photonic mixer device is an optical sensor element based on a time of flight method, wherein light pulses are emitted and the signal time of flight is measured. In this way, for example, a three-dimensional model of the pieces of information thus captured can be determined.

One exemplary embodiment according to aspects of the invention provides for the optical sensor element to be controllable based on the at least one specified parameter. For example, a PTZ camera can be controlled based on the at least one specified parameter, so that the captured pieces of information of the PTZ camera capture an extreme close-up shot of the pest present in the area to be monitored instead of the area to be monitored. For this purpose, the PTZ camera can be tilted, panned and zoomed. For example, control servos of a PTZ camera can be used to determine the pieces of information captured by the PTZ camera in keeping with the at least one specified parameter, for example so as to enable detailed capturing of pieces of information of a region within the area to be monitored. If a photonic mixer device is used, this device can be controlled based on the at least one specified parameter, so as to emit light pulses directed at the pest, whereby pieces of information that can represent an extreme close-up shot of the pest are captured by the photonic mixer device.

According to one exemplary embodiment according to aspects of the invention, the captured pieces of information are evaluated by way of an evolved computer vision algorithm, and in particular by way of a background subtraction algorithm. An evolved computer vision algorithm and/or a background subtraction algorithm can be easily implemented as hardware and/or software, for example. It is possible to effectively evaluate changes in captured pieces of information, wherein the captured pieces of information in particular represent one or more recorded images. An exemplary background subtraction algorithm is based on what is known as a Gaussian mixture model, which can be used to recognize a movement.

For example, the captured pieces of information can represent a video recording of the area to be monitored. If the captured pieces of information are captured by an optical sensor element, wherein the optical sensor element is statically arranged so that the captured pieces of information are indicative of an area that does not change, initially a model of the area in an image space can be created from the captured pieces of information, for example. Furthermore, it is possible to create multiple consecutive models of the area in an image space from the captured pieces of information, so that a comparison can be carried out between these models. As a result of the comparison, it is possible to estimate regions that differ from the other created models. These regions in which differences can be established can be the subject of more in-depth examinations, for example in that the region can be specified by at least one parameter, so that a second capturing of pieces of information, which, for example, represent a detailed image of the region, can take place.

If the consecutive models based on the first captured pieces of information or based on the second captured pieces of information are captured within a relatively short chronological sequence, for example within a defined time interval, an above-described comparison within the scope of an evaluation of captured pieces of information may be indicative of the presence of a pest even if pieces of information are not captured in a static manner. The capturing of pieces of information can take place in such a way, for example, that the optical sensor element for capturing pieces of information is arranged on a drone or on a device displaceable along a ground. If the first capturing of pieces of information takes place at relatively short intervals, it is possible to compare consecutive models with one another even if pieces of information are not captured in a static manner. For example, the time lag between captured pieces of information for which depicted models are to be compared must be so short that the depicted models are substantially similar to one another.

Furthermore, the captured pieces of information can be evaluated with respect to discontinuities so as to detect the presence of a pest. A discontinuity is understood to mean, for example, that the area to be monitored is a flat surface, for example. Accordingly, the captured pieces of information can be evaluated with respect to any unevenness in this otherwise flat surface. This unevenness can be a discontinuity, for example, which may be indicative of the presence of a pest within the area to be monitored.

For example, a detection and classification of vermin and/or pests or an identification of vermin and/or pests could be carried out as one of the possible applications and/or uses of one of the exemplary embodiments according to aspects of the invention.

In a further embodiment of the invention, at least one of the devices for carrying out the method is an electronic device. In particular, communication can take place via a communication system between a mobile device, such as a smart phone, a laptop, a tablet, a wearable, a computational engine, a linked computational engine, and at least one further device, such as a server, or a camera. According to one exemplary embodiment, the device according to all aspects of the invention comprises a communication interface. For example, the communication interface is configured for wired or wireless communication. The communication interface is a network interface, for example. The communication interface is configured, for example, to communicate with a communication system. Examples of a communication system include a local area network (LAN), a wide area network (WAN), a wireless network (such as according to the IEEE 802.11 standard, the Bluetooth (LE) standard and/or the NFC standard), a wired network, a mobile communication network, a telephone network and/or the Internet. A communication system can include the communication with an external computer, for example via an Internet connection.

According to one exemplary aspect of the invention an alternative device is described, comprising at least one processor and at least one memory including computer program code, wherein the at least one memory and the computer program code are configured to carry out and/or to control at least one method according to the aspects of the invention together with the at least one processor. A processor shall be understood to mean, for example, a control unit, a microprocessor, a microcontrol unit such as a microcontroller, a digital signal processor (DSP), a graphics processing unit (PGU), an application-specific integrated circuit (ASIC) or a field programmable gate array (FPGA).

For example, an exemplary device furthermore comprises means for storing pieces of information, such as a program memory and/or a main memory. For example, an exemplary device according to aspects of the invention furthermore comprises respective means for receiving and/or sending pieces of information via the network, such as a network interface. For example, exemplary devices according to aspects of the invention are connected and/or connectable to one another via one or more networks.

An exemplary device according to aspects of the invention is or comprises a data processing system, for example, which in terms of software and/or hardware is configured to be able to carry out the respective steps of an exemplary method according to the aspects of the invention. Examples of a data processing system include a computer, a desktop computer, a server, a thin client, a computational engine, a linked computational engine and/or a portable computer (mobile device), such as a laptop computer, a tablet computer, a wearable, a personal digital assistant or a smart phone.

According to one exemplary embodiment of the invention, a computer program is also described, which comprises program instructions that prompt a processor to carry out and/or control an exemplary method according to aspects of the invention when the computer program is running on the processor. An exemplary program according to aspects of the invention can be stored in or on a computer-readable storage medium, which includes one or more programs.

According to one exemplary embodiment according to aspects of the invention, a computer-readable storage medium is also described, which includes a computer program according to the aspects of the invention. A computer-readable storage medium can be designed as a magnetic, electric, electromagnetic, optical and/or other storage medium, for example. Such a computer-readable storage medium is preferably physically present (which is to say “touchable), for example designed as a data carrier device. Such a data carrier device is portable or fixedly installed in a device, for example. Examples of such a data carrier device include random access volatile or non-volatile memories (RAM), such as NOR flash memories, or sequential access volatile or non-volatile memories, such as NAND flash memories and/or read-only memories (ROM) or read-write memories. Computer-readable, for example, shall be understood to mean that a computer or a data processing system, such as a processor, is able to read (out) and/or write to the storage medium.

According to a further aspect of the invention a system is described, comprising multiple devices, and in particular an electronic device and a device for capturing pieces of information, which, in particular, comprises means for capturing pieces of information, wherein the devices together are able to carry out a method according to the aspects of the invention.

An exemplary system according to the aspects of the invention comprises an exemplary device for capturing pieces of information, and additionally one further device, such as an electronic device or a server for carrying out an exemplary method according to aspects of the invention.

For example, a device for capturing pieces of information can comprise an optical sensor element which can be used to capture pieces of information two-dimensionally and/or three-dimensionally. Furthermore, the optical sensor element can be a fixedly installed camera, such as a PTZ camera. As an alternative, the optical sensor element can be arranged on a drone or on a device displaceable on the ground, for example. It is furthermore conceivable that, for example, the drone and/or the device displaceable on the ground can be controlled based on the at least one specified parameter according to the invention. In the case of the drone, this drone can be moved to a position deviating from the current position based on the at least one specified parameter. The same applies to the device displaceable on the ground. In this way, for example, a second capturing of pieces of information indicative of a capturing and/or a detailed capturing of a pest can also take place by way of a movement of the drone or of the device displaceable on the ground toward a pest. Furthermore, in particular a PTZ camera and/or a photonic mixer device can be arranged both on the drone and on the device displaceable along the ground, so as to be able to supply specified pieces of information.

The exemplary embodiments of the present invention described above in the present description shall be understood to also have been disclosed in all combinations with one another. In particular, exemplary embodiments shall be understood to have been disclosed with respect to the different aspects.

In particular, corresponding means for carrying out the method by way of exemplary embodiments of a device according to the aspects of the invention shall be considered disclosed by the above or the following description of method steps according to preferred embodiments of a method. Likewise, the disclosure of means of a device for carrying out a method step shall also be considered to have disclosed the corresponding method step.

Further exemplary embodiments of the invention can be derived from the following detailed description of several exemplary embodiments of the present invention, in particular in conjunction with the figures. However, the figures are only intended to serve illustration purposes, not, however, to determine the scope of protection of the invention. The figures are not true to scale and are only intended to reflect the general concept of the present invention. In particular, features that are present in the figures shall in no way be construed to be necessary integral components of the present invention.

### BRIEF DESCRIPTION OF THE DRAWINGS

In the drawings:

FIG. 1 shows a flow chart of one exemplary embodiment of a method;

FIG. 2 shows a schematic representation of one exemplary embodiment of a first embodiment;

FIG. 3 shows a schematic representation of one exemplary embodiment of a second embodiment;

FIG. 4 shows a schematic representation of one exemplary embodiment of a third embodiment;

FIG. 5 shows a schematic representation of one embodiment of a deep CNN;

FIG. 6 shows a block diagram of one exemplary embodiment of a device; and

FIG. 7 shows a block diagram of one exemplary embodiment of a system.

### DETAILED DESCRIPTION OF THE INVENTION

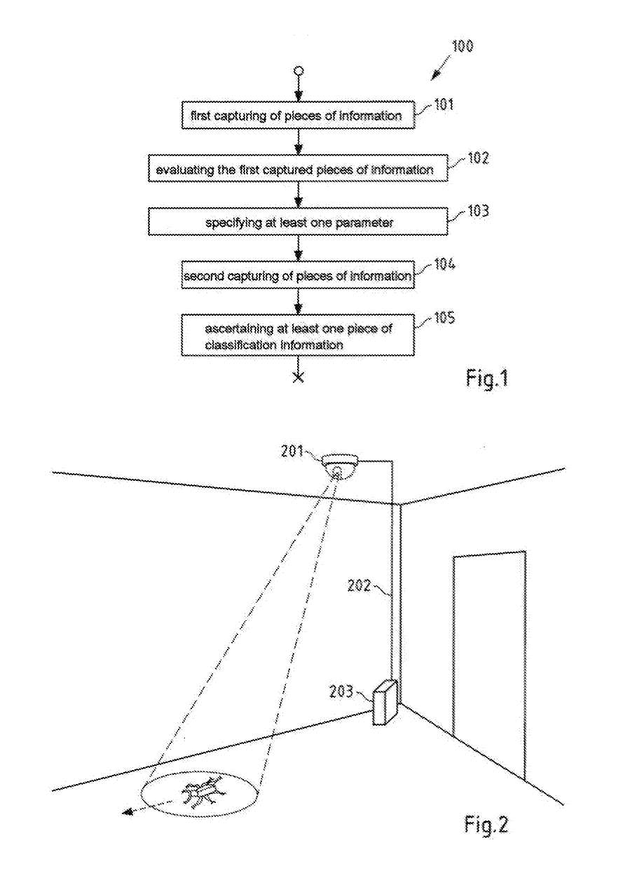

FIG. 1 shows a flow chart 100 of one exemplary embodiment of a method according to a first aspect of the present invention. For example, the flow chart 100 can be carried out and/or controlled by a device, such as a computational engine 720 of FIG. 7.

In a first step 101, a first capturing of pieces of information takes place, wherein the first captured pieces of information are indicative of an area to be monitored.

A second step 102 provides for the first captured pieces of information to be evaluated, wherein the first captured pieces of information are evaluated for the presence of an object. For example, the first captured pieces of information can be evaluated as to whether an object is present in the area to be monitored, wherein the object was not present in the area to be monitored at an earlier point in time. This may take place, for example, according to the above-described manner of evaluating a different in the first captured pieces of information. Significant differences, for example, can be triggered in particular by the movement of a person or an object.

In a third step 103, at least one parameter is specified based on the evaluation, wherein the at least one specified parameter is indicative of a capturing of the object. For example, the specified pieces of information can comprise a region within the area to be monitored in which the object is present. Accordingly, it is possible to carry out a further capturing of pieces of information., wherein the capturing of these further pieces of information is limited to the region within the area to be monitored.

According to step 104, a second capturing of pieces of information based on the at least one specified parameter takes place, wherein the second captured pieces of information are indicative of the object. By capturing pieces of information based on the at least one specified parameter, it can be ensured that pieces of information are captured, these captured pieces of information being indicative of the object. For example, in this way more details with respect to the object can be captured since, as a result of capturing pieces of information based on the at least one specified parameter, it is possible, for example, to capture a region and/or a subregion within the area to be monitored.

A fifth step 105 provides that at least one piece of classification information is ascertained based on the second captured pieces of information, wherein the piece of classification information is indicative of a classification of the object.

The exemplary flow chart 100 can moreover comprise one or more further features and/or aspects that are described above in connection with the description of the present invention. For example, the object may be a pest, and the at least one piece of classification information is furthermore indicative of a pest type.

Furthermore, steps 104 and 105 can be repeated at least once or several times, so that, for example, one or more further pieces of classification information can be ascertained, wherein, for example, the second pieces of information captured in step 104 can be captured in a chronological sequence, such as at a predefined time interval apart from one another.

FIG. 2 shows a schematic representation of one exemplary embodiment of a first embodiment of the invention. In the present example, a device for capturing pieces of information, for example a PTZ camera 201 mountable on a ceiling, is used, for example according to a device 710 according to FIG. 7. The PTZ camera 201 has a communication connection 202 to a further device 203, such as a device 720 according to FIG. 7. The device 203 can be a computational engine, for example, which at least provides monitoring for the presence of an object, such as a pest, for example according to step 102 of FIG. 1. The monitoring can be carried out, for example, based on first captured pieces of information, such as pieces of video information, which can be captured by the PTZ camera 201 and, for example, which can be captured according to step 101 of FIG. 1. Furthermore, the device 203 can initiate and/or carry out a control of the PTZ camera, for example based on at least one specified parameter, such as according to step 103 according to FIG. 1. The control of the PTZ camera, for example, can enable a second capturing of pieces of information, for example according to step 104 of FIG. 1, based on the at least one specified parameter, wherein the second captured pieces of information are indicative of the object, such as the pest. For example, the second captured pieces of information can represent a medium close-up shot and/or a close-up shot and/or an extreme close-up shot of the object, such as a pest. Furthermore, the device 203 can carry out an ascertainment of at least one piece of classification information, for example according to step 105 according to FIG. 1. Furthermore, for example by using an artificial neural network, for example a deep CNN 500 according to FIG. 5 can be carried out, and optionally an action based on the ascertained at least one piece of classification information can be carried out by the device 203, or the execution thereof can be initiated.

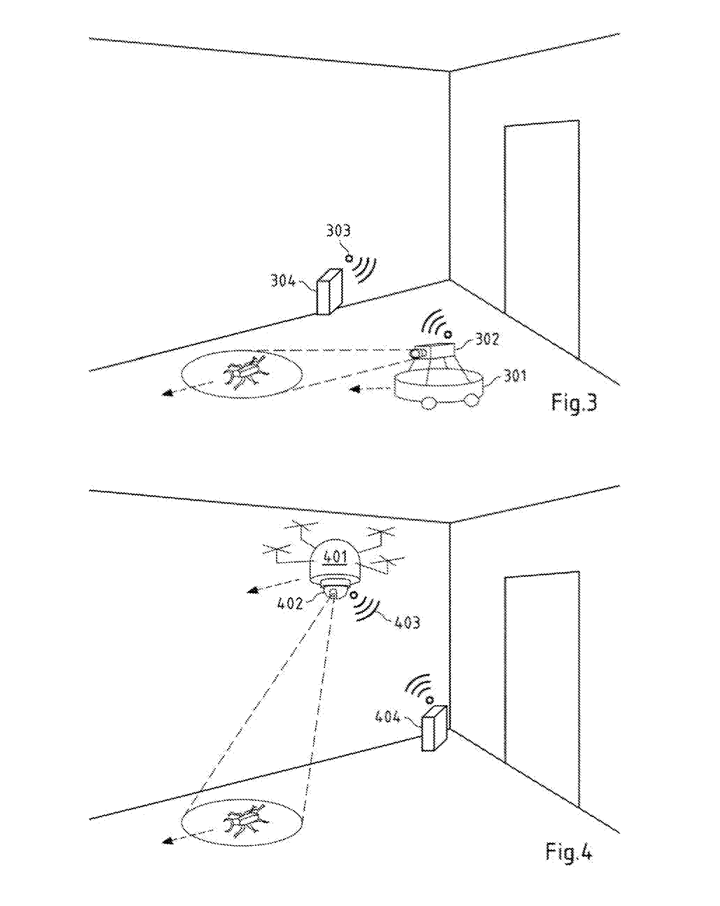

FIG. 3 shows a schematic representation of one exemplary embodiment of a second embodiment of the invention. In contrast to the exemplary embodiment of a first embodiment of the invention shown in FIG. 2, the embodiment comprises a device 301 displaceable on the ground, which includes a device for capturing pieces of information 302, such as device 710 according to FIG. 7.

In the present example, the device for capturing pieces of information 302 comprises a 3D sensor, such as a photonic mixer device. Furthermore, the communication connection 303 between a further device 304, such as a device 720 according to FIG. 7, is designed as a wireless communication connection. The device 304 can control the movement of the device 301 displaceable on the ground, for example. This control can occur, for example, based on a certain difference, which was evaluated, for example, within the scope of the evaluation of the first captured pieces of information according to step 102 according to FIG. 1. For example, for this purpose a comparison can take place between a current captured area to be monitored and a previously determined model and/or an image of the area to be monitored. If the presence of an object, such as a pest in the present example, was evaluated within the scope of the evaluation of the first captured pieces of information, the device 304 can specify at least one parameter, for example according to step 103 of FIG. 1, so that the device 301 displaceable on the ground is able to carry out a second capturing of pieces of information, wherein the second captured pieces of information can represent a medium close-up shot and/or a close-up shot and/or an extreme close-up shot of the object, such as a pest. The device 301 can carry out movements for the second image and does not have to pause in a static manner to achieve this image. Furthermore, the device 304 can carry out an ascertainment of at least one piece of classification information, for example according to step 105 according to FIG. 1, such as by using an artificial neural network, such as a deep CNN 500 according to FIG. 5, and optionally carry out an action based on the ascertained at least one piece of classification information, or initiate the execution thereof.

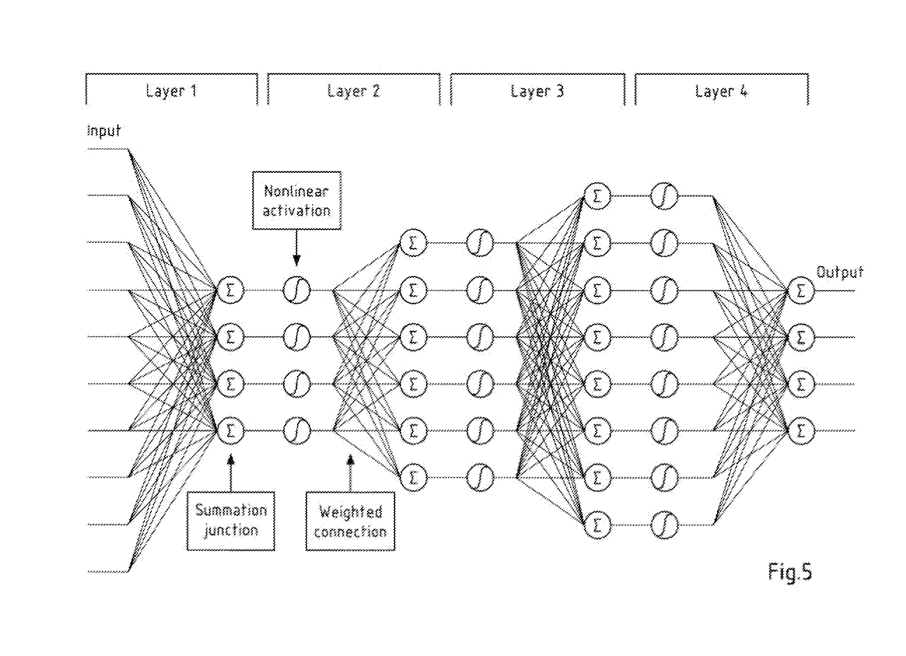

FIG. 4 shows a schematic representation of one exemplary embodiment of a third embodiment. In contrast to the exemplary embodiment of a second embodiment shown in FIG. 3, the embodiment comprises a drone 401, which includes a device for capturing pieces of information 402, such as device 710 according to FIG. 7.

In the present example, the device for capturing pieces of information 402 comprises a camera. Furthermore, the communication connection 403 between a further device 404, such as a device 720 according to FIG. 7, is designed as a wireless communication connection. The device 304 can control the movement of the drone 401, for example. This control can, for example, take place based on a certain difference between a flat surface of a ground and the current captured area to be monitored, wherein the difference was evaluated, for example, within the scope of the evaluation of first captured pieces of information according to step 102 according to FIG. 1. If the presence of an object, such as a pest in the present example, was evaluated within the scope of the evaluation of the first captured pieces of information, the device 304 can specify at least one parameter, for example according to step 103 of FIG. 1, so that the drone 401 is able to carry out a second capturing of pieces of information, wherein the second captured pieces of information can represent a medium close-up shot and/or a close-up shot and/or an extreme close-up shot of the object, such as a pest. The drone 401 can carry out movements for the second recording and does not have to pause in a static manner to achieve this recording. Furthermore, the device 404 can carry out an ascertainment of at least one piece of classification information, for example according to step 105 according to FIG. 1, such as by using an artificial neural network, such as a deep CNN 500 according to FIG. 5, and optionally carry out an action based on the ascertained at least one piece of classification information, or initiate the execution thereof.

FIG. 5 shows a schematic representation of one embodiment of an artificial neural network 500, which a deep CNN in the present example. In the present example, the deep CNN will be described as one exemplary embodiment based on captured pieces of information, such as second captured pieces of information according to step 104 of FIG. 1, which were captured, for example, by an optical sensor element, such as a camera or a 3D sensor 712 of FIG. 7, and which can represent pieces of image information. For example, the captured pieces of information, which represent the individual pixels of an image, for example, can be used as input parameters for the deep CNN network 500. In a first layer, which is Layer 1, of the deep CNN 500, an operation, which in the present example is a summation function, is carried out with the aid of the entered pieces of information. The results available from the entered pieces of information after passing through the first layer are entered into a second layer, which is Layer 2, in which the operation carried out is a non-linear activation function, such as a so-called softmax function. The output parameters, after the non-linear activation function has been carried out, are entered into a fully connected network, which again provides output parameters as input parameters to further summation nodes. The summation nodes carry out a corresponding summation function. Thereafter, the results obtained are entered as input parameters into a third layer, which is Layer 3, of the deep CNN, which initially carries out a non-linear activation function, and are entered into further summation nodes after being linked and passing through a fully connected network. After the corresponding operation has been carried out, the results thereof are entered as input parameters into a fourth layer, which is Layer 4, of the deep CNN, which initially can carry out a non-linear activation function, for example, and supplies the results to a respective summation node via a fully connected network. Thereafter, the artificial neural network 500 can output at least one piece of classification information.

The neural network 500 can be trained during an initial phase, for example, so that it is possible to ascertain at least one piece of classification information. Furthermore, the neural network can continue to learn during ongoing operation, so as to increase the likelihood that least one accurate piece of classification information is output and, compared to a non-learning classification, such as a static algorithm, thereby supply better because more accurate results of the classification in the form of a piece of classification information. For example, the individual connections of a fully connected network can be dynamically re-weighted for this purpose, which is to say during ongoing operation and continually, wherein, for example, the value of an associated piece of weighting information is increased when an applicable association via the connection has taken place.

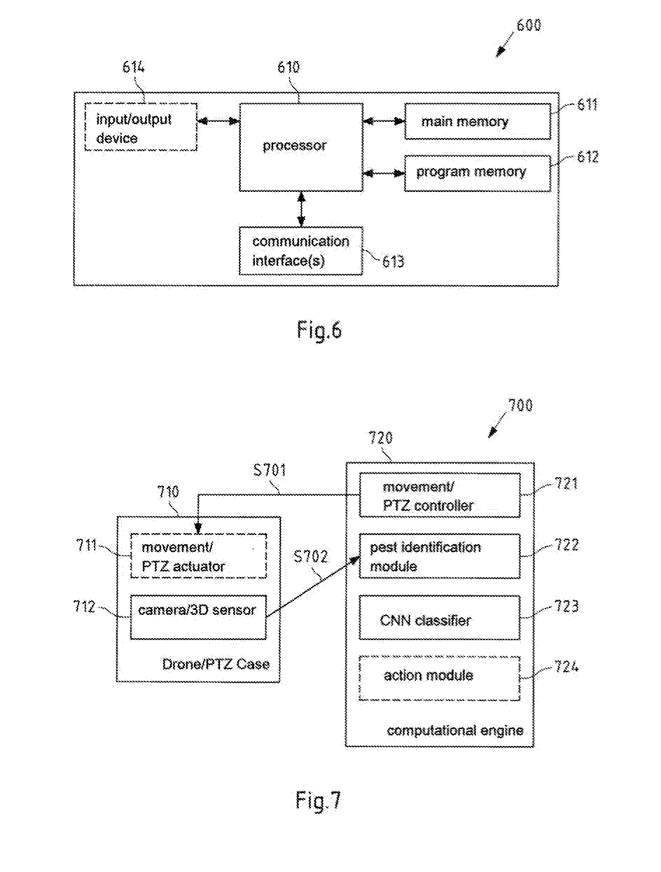

FIG. 6 shows a block diagram of one exemplary embodiment of a device 600, which, in particular, is able to carry out an exemplary method according to the first aspect of the invention. The device 600 is, for example, a device according to the second aspect of the invention or a system according to the third aspect of the invention.

For example, the device 600 can thus be a computer, a desktop computer, a server, a server cloud, a thin client, a computational engine, a linked computational engine or a portable computer (mobile device), such as a laptop computer, a tablet computer, a personal digital assistant (PDA) or a smart phone.

The processor 610 of the device 600 is in particular designed as a microprocessor, a microcontrol unit, a microcontroller, a digital signal processor (DSP), a graphics processing unit (PGU), an application-specific integrated circuit (ASIC) or a field programmable gate array (FPGA).

The processor 610 can execute program instructions, which may be stored in the program memory 612, and, for example, can store intermediate results or the like in the main memory 611 (also referred to as RAM). For example, the program memory 612 is a non-volatile memory, such as a flash memory, a magnetic memory, an EEPROM (electrically erasable programmable read-only) memory and/or an optical memory. The main memory 611, for example, is a volatile or non-volatile memory, and in particular a random access memory (RAM), such as a static RAM memory (SRAM), a dynamic RAM memory (DRAM), a ferroelectric RAM memory (FeRAM) and/or a magnetoresistive RAM memory (MRAM).

The program memory 612 is preferably a local data carrier fixedly connected to the device 600. Data carriers fixedly connected to the device 600 are hard drives, for example, which are installed in the device 600. Alternatively, the data carrier can also be a data carrier that is detachably connectable to the device 600, for example, such as a memory stick, a removable medium, a portable hard drive, a CD, a DVD and/or a diskette.

For example, the program memory 612 can the operating system and/or the firmware of the device 600, which during start-up of the device 600 is loaded at least partially into the main memory 611 and executed by the processor 610. In particular, at least a portion of the kernel of the operating system and/or of the firmware is loaded into the main memory 611 and executed by the processor 610 during the start-up of the device 600. The operating system of the device 600 may be a Windows, UNIX, Linux, Android, Apple iOS and/or MAC operating system, for example.

The operating system, in particular, allows the device 600 to be used for data processing. For example, it manages operating resources, such as the main memory 611 and the program memory 612, communication interface(s) 613, and an optional input and output device 614, but also makes program interfaces for fundamental functions available to other functions and controls the execution of programs.

The processor 610 can control the communication interface(s) 613, which may be a network interface, for example, and can be designed as a network interface card, a network module and/or a modem. The communication interface(s) 613 is or are in particular configured to establish a connection between the device 600 and other devices, in particular via a (wireless) communication system, such as a network, receive (via the communication system) and transmit (via the communication system). Examples of a communication system include a local area network (LAN), a wide area network (WAN), a wireless network (such as according to the IEEE 802.11 standard, the Bluetooth (LE) standard and/or the NFC standard), a wired network, a mobile communication network, a telephone network and/or the Internet.

Furthermore, the processor 610 can control at least one optional input and output device 613. The input and output device 614 is, for example, a keyboard, a mouse, a display unit, a microphone, a touch-sensitive display unit, a speaker, a reader, a drive and/or a camera for capturing pieces of information. The input and output device 614 can, for example, accept inputs from a user and forward them to a processor 610 and/or receive and/or output pieces of information for the user of the processor 610.

FIG. 7 shows a schematic block diagram of a system 700 according to an exemplary aspect of the present invention. The system 700 comprises a device 710 for capturing pieces of information, which in particular includes means for capturing pieces of information, such as a drone and/or a housing comprising a PTZ camera (PTZ case). Furthermore, the system 700 comprises a further device 720, for example a computational engine, which may be a device 600 of FIG. 6, for example.

The device 710 can comprise a camera and/or a 3D sensor 712 for capturing pieces of information, for example, and optionally the device 710 can comprise movement and/or PTZ actuators, wherein, for example in the case of a drone and/or a device displaceable on the ground as one exemplary embodiment of a device 710, this device can be controlled based on at least one specified parameter, wherein the at least one specified parameter causes and/or carries out an action of the actuator corresponding to the at least one specified parameter. Furthermore, the camera and/or the 3D sensor 712 can be controlled by way of at least one specified parameter, for example in that a corresponding actuator 711 causes a movement of the camera and/or of the 3D sensor. For example, one or more servos can be used as an actuator, both with respect to a movement of a drone and/or a device displaceable on the ground, and for moving a camera and/or a 3D sensor.

Furthermore, the device 720 can comprise a movement and/or PTZ controller 721, a pest identification module 722, a CNN classifier 723, and optionally an action module 724, for example.

For example, the movement and/or PTZ controller 721 specifies at least one parameter, for example in step 103 of FIG. 1, and in step S701 provides this specified parameter to the device for capturing pieces of information 710, which based on the at least one specified parameter is able to carry out a second capturing of pieces of information, wherein the second captured pieces of information, for example, are indicative of a pest, which was identified/detected by a pest identification module 722, for example, or evaluated as part of an evaluation of first captured pieces of information. The pest identification module 722 can, for example, contain an evolved computer vision algorithm for the evaluation for the presence of a pest, wherein first captured pieces of information are evaluated, for example. The first captured pieces of information can be captured by the device 710, for example, and transmitted to the pest identification module in step S702. The first captured pieces of information of the device 710 may be indicative of an area to be monitored, for example. For example, the pest identification module can identify pests in the above-described manner by evaluating the first captured pieces of information for the presence of a pest.

If the transmitted pieces of information in step S702 are second captured pieces of information based on the at least one specified parameter, for example if the second captured pieces of information represent an extreme close-up shot of a pest, at least one piece of classification information can be ascertained based on the second captured pieces of information, for example by way of the CNN classifier 723, wherein the piece of classification information is indicative of a classification, for example of a pest.

Optionally, based on the ascertained piece of classification information, an action module 724 can initiate at least one action, for example a measure for controlling the pest and/or the transmission of a notification to a predetermined user, and/or bring about the initiation of the measure.

The exemplary embodiments of the present invention described in the present specification, and the respective optional features and properties described in this regard, shall also be understood to have been disclosed in all combinations with one another. In particular—unless explicitly stated to the contrary—the description of a feature covered by an exemplary embodiment in the present invention shall not be understood to mean that the feature is indispensable or essential for the function of the exemplary embodiment. The sequence of the method steps in the individual flow charts described in the present specification is not mandatory, and alternative sequences of the method steps are conceivable. The method steps can be implemented in a different manner. For example, an implementation as software (using program instructions), hardware or a combination of the two is conceivable for the implementation of the method steps.

Expressions such as “comprise,” “include,” “contain,” “have” and/or the like used in the claims to not preclude further elements or steps. The wording “at least partially” covers both the case of “partially” and the case “completely.” The expression “and/or” shall be understood to the effect that both the alternative and the combination are to be considered disclosed, which is to say “A and/or B” means “(A) or (B) or (A and B).” The use of the definite article does not preclude a plurality. An individual device can carry out the functions of several units or devices described in the claims. Reference numerals provided in the claims shall not be construed as restrictions of the means and steps used.

What is claimed is:

1. A method, comprising:
a first capturing of pieces of information, wherein the first captured pieces of information are indicative of an area to be monitored;
evaluating the first captured pieces of information, wherein the first captured pieces of information are evaluated for the presence of an object;
specifying at least one parameter based on the evaluation, wherein the at least one specified parameter is indicative of a capturing of the object;
a second capturing of pieces of information based on the at least one specified parameter, wherein the second captured pieces of information are indicative of the object; and
ascertaining at least one piece of classification information based on the second captured pieces of information, wherein the piece of classification information is indicative of a classification of the object.

2. The method according to claim 1, wherein the object is a pest, and the at least one piece of classification information is indicative of a pest type.

3. The method according to claim 1, wherein the ascertainment of at least one piece of classification information takes place by way of a neural network, the second captured pieces of information being used as input parameters for the neural network, and at least one piece of classification information being output by the neural network.

4. The method according to claim 1, wherein the steps of the second capturing of pieces of information and of ascertaining at least one piece of classification information are carried out at least twice so as to obtain at least two pieces of classification information.

5. The method according to claim 4, furthermore comprising:
ascertaining a piece of result information based on at least two pieces of classification information, wherein the piece of result information is indicative of the most likely classification of the object.

6. The method according to claim 2, furthermore comprising:
outputting and/or triggering a predefined action as a function of the piece of result information, wherein the predefined action is indicative of a recommendation of a measure based on the at least one ascertained piece of classification information and/or piece of result information.

7. The method according to claim 1, wherein the first capturing of pieces of information and/or the second capturing of pieces of information take place by way of an optical sensor element.

8. The method according to claim 7, wherein the optical sensor element can be controlled based on the at least one specified parameter.

9. The method according to claim 1, wherein the first captured pieces of information are evaluated by way of an evolved computer vision algorithm.

10. A device, which is configured or comprises appropriate means to carry out and/or to control a method according to claim 1.

11. A device, comprising at least one processor and at least one memory including computer program code, wherein the at least one memory and the computer program code are configured to carry out and/or to control at least one method according to claim 1 together with the at least one processor.

12. A computer program, comprising program instructions that prompt a processor to carry out and/or to control a method according to claim 1 when the computer program is executed on the processor.

13. A computer-readable storage medium, comprising a computer program according to claim 12.

14. A system, comprising:
at least one device according to claim 10; and
at least one device for capturing pieces of information, including means for capturing pieces of information,
the devices being designed and/or configured to carry out a method according to claim 1.

15. The method according to claim 3, wherein the ascertainment of at least one piece of classification information takes place by way of a convolutional neural network (CNN), support vector machines (SVM) or self-organizing maps (SOM), the second captured pieces of information being used as input parameters for the neural network, and at least one piece of classification information being output by the neural network.

16. The method according to claim 15, wherein the ascertainment of at least one piece of classification information takes place by way of a convolutional neural network (CNN), the second captured pieces of information being used as input parameters for the neural network, and at least one piece of classification information being output by the neural network.

17. The method according to claim 9, wherein the first captured pieces of information are evaluated by way of a background subtraction algorithm.
